(19) United States
(12) Patent Application Publication
(10) Pub. No.: US 2009/0010747 A1
(43) Pub. Date: Jan. 8, 2009

(54) PULL AND LIFT SYSTEM FOR TRANSPORTING ROOFING MATERIALS

(76) Inventor: RICHARD W. POGUE, St. Peters, MO (US)

Correspondence Address: CHARLES C. MCCLOSKEY, 763 S. NEW BALLAS ROAD STE. 170, ST. LOUIS, MO, 63141, US

(21) Appl. No.: 12/170,808

(22) Filed: Jul. 10, 2008

Related U.S. Application Data
(63) Continuation of application No. 11/064,245, filed on Feb. 22, 2005.

(51) Int. Cl. B66F 9/19

(52) U.S. Cl. 414/661

(57) ABSTRACT

The pull and lift system of the present invention transfers roofing materials from the pullbar extended position 14, FIG. 1, located at the headboard 1a of a truck bed to the lift table 6 shown in FIG. 1, by hydraulic rams 8, FIG. 1. The pull and lift system raises roofing material via the lift table 6 so as to eliminate excessive bending by the person picking up said material, by hydraulic rams 9, shown in FIG. 4.

### CROSS REFERENCE TO RELATED APPLICATION

This continuation application claims priority to the pending non-provisional application having a Ser. No. of 11/064,245 with a filing date of Jan. 13, 2005.

### SUMMARY OF THE INVENTION

One object of the pull and lift system of the present invention is to transfer roofing and other construction materials longitudinally and mechanically on a truck bed from the pullbar extended position on a truck bed 14, FIG. 1, located at lo the headboard 1a of the truck bed to the lift table 6 shown in FIG. 1. This is done by hydraulic rams 8, shown in FIG. 1.

Another object of the present invention is to lift roofing and other construction materials, often upon pallets, vertically from a truck bed with a lift table 6 so as to eliminate excessive bending by the person picking up said material. This is done by hydraulic rams 9, shown in FIG. 4.

### BRIEF DESCRIPTION OF THE DRAWINGS

In referring to the drawings,

FIG. 1 is a plan view of the pull and lift system of the present invention with the pull bar in extended position;

FIG. 2 is a plan view of the pull and lift system of the present invention with the pull bar in retracted position;

FIG. 3 is a side view of the pull and lift system of the present invention with the lift table 13 at the lowered position 15 at the rear of the truck bed;

FIG. 4 is a side view of the pull and lift system of the present invention with the lift table 13 at the elevated position 17 at the rear of the truck bed;

FIG. 5 is an end elevation view of the pull and lift system of the present invention with the lift table 13 at the lowered position 15 at the rear of the truck bed;

FIG. 6 is an end elevation view a of the pull and lift system of the present invention with lift table 13 at the elevated position 17 at the rear of the bed; and,

FIGS. 7 and 8 are photographs of safety stripes 5.

The same reference numerals refer to the same parts throughout the various figures.

### DESCRIPTION OF THE PREFERRED EMBODIMENT

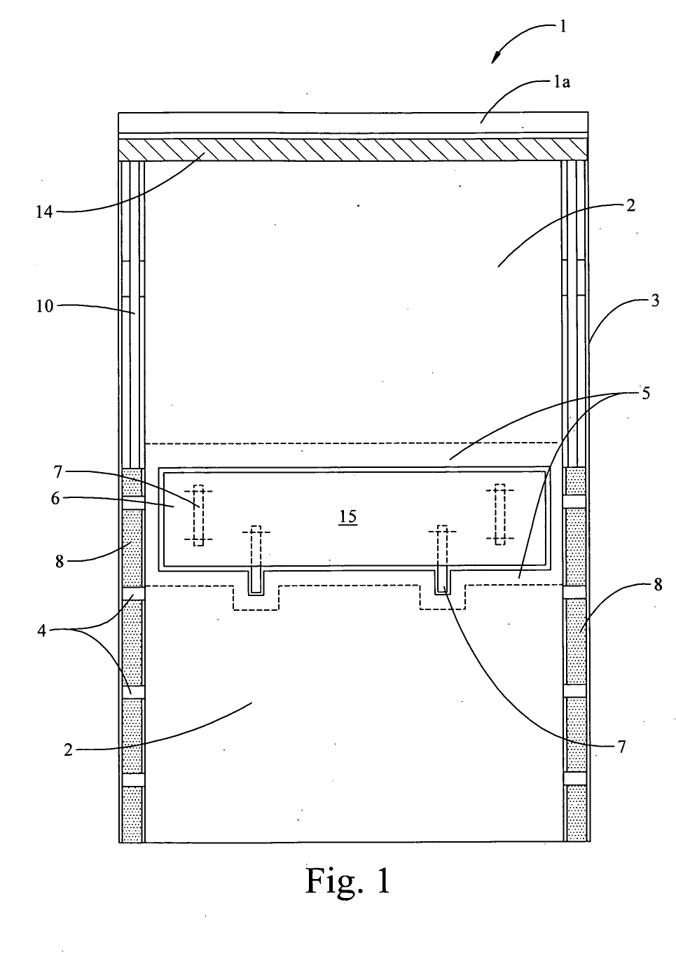

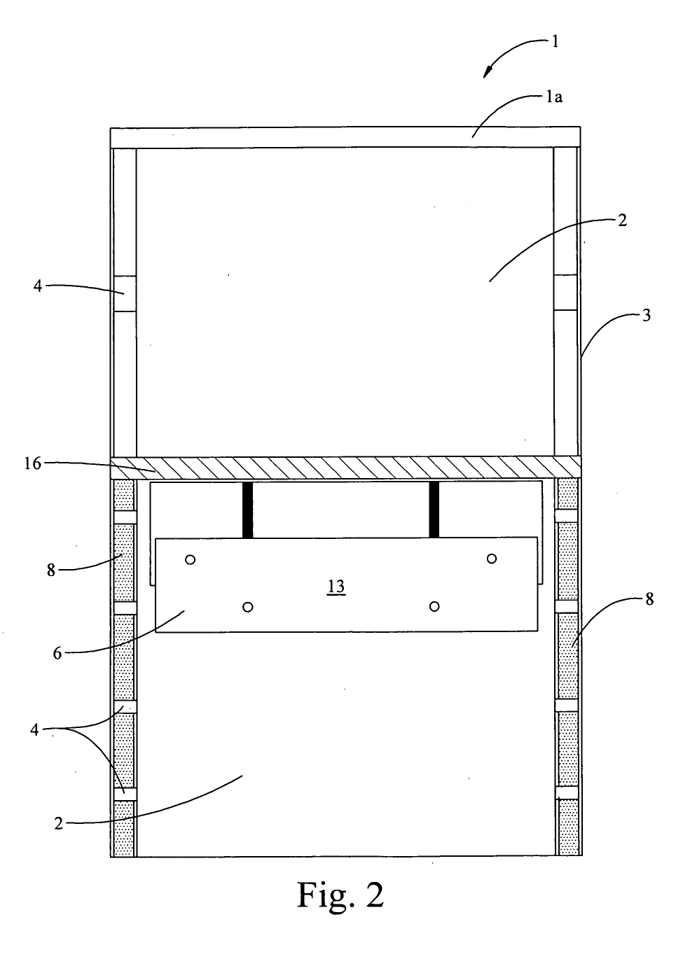

The pull and lift system of the present invention is illustrated in the lo drawings at 1. The pull and lift system includes a pull bar shown in extended position in FIG. 1 at 14, and in retracted position at 16 in FIG. 2.

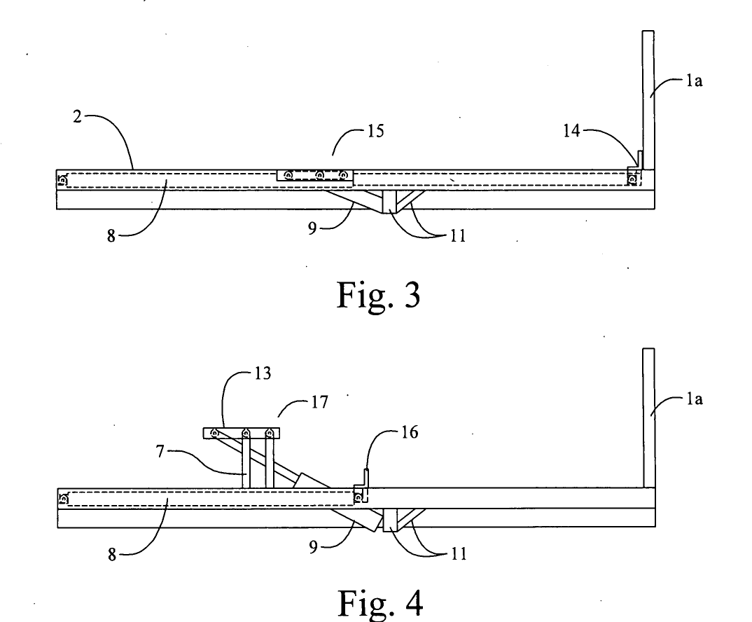

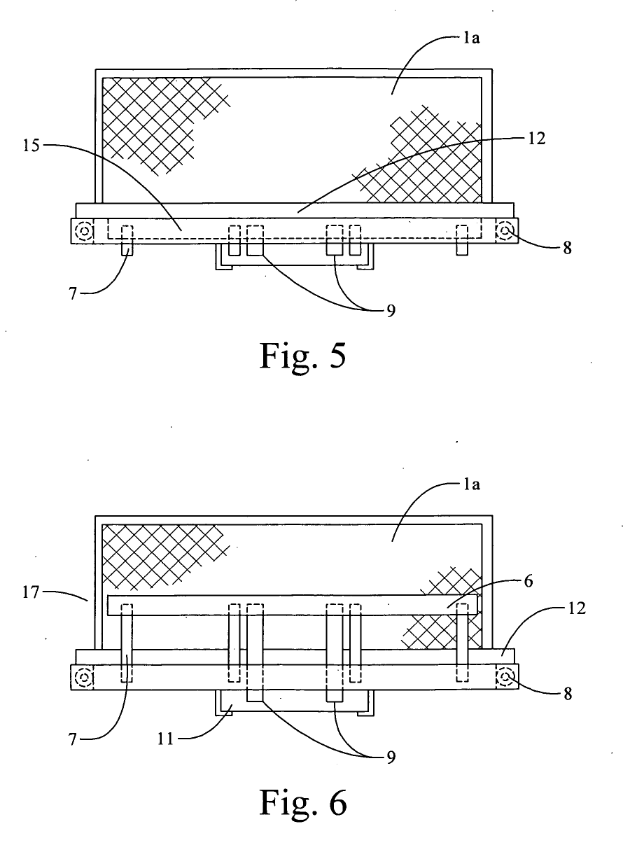

The pull and lift system also includes a lift table 6 shown in lowered position at 15 in FIG. 3, and having a raised position shown in FIG. 4.

The pull and lift system has the ability to transfer roofing materials from the pullbar extended position 14, FIG. 1, located at the headboard 1a of a truck bed to the lift table 6 shown in FIG. 1. The transfer is accomplished by dual hydraulic rams 8 arranged in parallel and the transfer ends at the pull bar retracted position 116 shown in FIG. 2.

The pull and lift system also has the ability to raise roofing material via the lift table 6 so as to eliminate excessive bending by the person picking up said material. The power to raise the lift table 13, FIG. 4 is provided by hydraulic rams 9, shown in FIG. 4 as parallel and rotating about a common axis.

In one embodiment, the pull bar extended as at 14, FIG. 1, drags roofing material from the headboard 1a at the front of the truck bed to the lift table 13 at the lowered position 15 at the rear of the truck bed. This is done with drastically increased range of motion from the prior art, and at double the load capacity of the load capacity of the prior art.

In another embodiment, the lift table, lowered as at 15, raises roofing material to a height exceeding that of the prior art to the lift table raised position as at 17 shown in FIG. 4.

In another embodiment, moving parts of the pull and lift system are signified by safety stripes 5, FIGS. 1, 7 and 8 to convey to an operator to “keep clear” of moving parts.

In another embodiment, the pull and lift system 1 is powered by an electric motor.

In another embodiment, the pull and lift system 1 is powered by a power take-off system or by a power steering pump located in the engine assembly of the vehicle.

As such, those skilled in the art will appreciate that the conception, upon which this disclosure is based, may readily be utilized as a basis for the designing of other structures, methods and systems for carrying out the several purposes of the present invention. Therefore, the claims include such equivalent constructions insofar as they do not depart from the spirit and the scope of the present invention.

I claim:

1. A system for transferring construction materials, such as palletized roofing, from a first position to a second position in relation to a flat truck bed, without bending by a user, comprising:
a pullbar extending transversely on a flat truck bed having a first extended position at a first position adjacent to a headboard of a truck bed to a second retracted position on a truck bed opposite a headboard of a truck bed, and longitudinally spaced on said truck bed from said headboard, said pullbar having a height approximately that of a pallet; and,
at least one single stage ram transferring said pullbar from said first position to said second position, said at least one single stage ram connecting to said pullbar wherein said pullbar remains upon the flat truck bed during usage, said at least one single stage ram locating within the flat truck bed, and said at least one single stage ram locating beneath said pullbar and below the construction materials.

2. The pull system for transferring construction materials from a first position to a second position according to claim 1 further comprising:
two spaced apart single stage hydraulic rams moving parallel to the plane of said truck bed and within the flat truck bed.

3. The pull system for transferring construction materials from a first position to a second position according to claim 1 further comprising:
said pullbar gripping the construction materials proximate the headboard and dragging the construction materials upon the flat truck bed into said second position.

4. A system for transferring construction materials relative to a truck flat bed from a first position to a second elevated position in relation to a flat truck bed with a headboard, without bending by a user, comprising:
a lift table extending transversely within said truck bed, said lift table having less width and less length than said truck flat bed and said lift table maintaining the construction materials generally parallel to said truck bed during usage; and,
at least one single stage ram raising said lift table vertically from a first position located adjacent a truck bed to a second elevated position located above said truck bed.

5. The system for transferring construction materials from a first position to a second elevated position according to claim 4 further comprising:
two parallel single stage hydraulic rams rotating about a common axis.

6. The system for transferring construction materials from a first position to a second elevated position according to claim 4 further comprising:
said lift table locating away from the headboard when in said second elevated position.

7. A system for transferring construction materials, such as palletized roofing, from a first position to a second position in relation to a flat truck bed, comprising:
a lift table locating within said truck bed;
a pullbar extending transversely on a truck bed having a first extended position at a first position adjacent to a headboard of a truck bed to a second position on a truck bed adjacent to said lift table, and longitudinally spaced on said truck bed from the headboard;
means for transferring said pullbar from said first position to said second position without detaching from said pullbar and within the truck bed; and,
means for transferring construction materials from said second position to a third position without tipping the materials, said construction materials transferring means extending from a location within the truck bed, and said third position being elevated with respect to said second position and said truck bed, being parallel to said truck bed, and being away from the headboard.

8. The system for transferring construction materials according to claim 7 wherein said pullbar transfer means includes at least one single stage hydraulic ram and said construction materials transfer means includes at least one single stage hydraulic ram.

9. The system for transferring construction materials according to claim 8 wherein said pullbar transfer means includes two spaced apart single stage hydraulic rams and said construction materials transfer means includes two single stage hydraulic rams rotating about a common axis.

10. The system for transferring construction materials according to claim 7 wherein said system is powered by one of an electric motor, a power take off system of the flat truck bed, and the power steering system of the flat truck bed.
